(19) United States
(12) Patent Application Publication
(10) Pub. No.: US 2026/0105884 A1
(43) Pub. Date: Apr. 16, 2026

(54) DISPLAY DEVICE, METHOD OF OPERATING THE DISPLAY DEVICE AND ELECTRONIC DEVICE INCLUDING THE DISPLAY DEVICE

(71) Applicant: Samsung Display Co., LTD., Yongin-si (KR)

(72) Inventors: WOONYONG LIM, Yongin-si (KR); JAEHYUN KOH, Yongin-si (KR); DOWON KIM, Yongin-si (KR); MIN-WEUN KIM, Yongin-si (KR)

(21) Appl. No.: 19/359,997

(22) Filed: Oct. 16, 2025

(30) Foreign Application Priority Data
Oct. 16, 2024 (KR) 10-2024-0141660

(51) Int. Cl. G09G 3/32

(52) U.S. Cl. CPC G09G 3/32; G09G 2300/0819; G09G 2300/0842; G09G 2300/0861; G09G 2320/0233; G09G 2320/0673

(57) ABSTRACT

A display device includes a display panel, a gate driver, a data driver, a gamma reference voltage generator which outputs an output gamma reference voltage to the data driver, and a driving controller which controls the gate driver, the data driver, and the gamma reference voltage generator. The driving controller includes a voltage level determiner which determines a target gamma reference voltage corresponding to a target luminance and a voltage compensation level determiner which determines an offset voltage to compensate for a deviation between a first output gamma reference voltage and the target gamma reference voltage, where the first output gamma reference voltages is the output gamma reference voltage prior to compensation thereof. The gamma reference voltage generator outputs a second output gamma reference voltage, which is obtained by applying the offset voltage to the first output gamma reference voltage, as the output gamma reference voltage.

This application claims priority to Korean Patent Application No. 10-2024-0141660, filed on October 16, 2024, and all the benefits accruing therefrom under 35 U.S.C. § 119, the content of which in its entirety is herein incorporated by reference.

### BACKGROUND

### 1. Field

Embodiments of the invention relate to a display device, a method of operating the display device, and an electronic device including the display device.

### 2. Description of the Related Art

A display device may include a display panel and a display panel driver. The display panel may include a plurality of gate lines, a plurality of emission lines, a plurality of data lines, and a plurality of pixels. The display panel driver may include a gate driver for providing gate signals to the gate lines, an emission driver for providing emission signals to the emission lines, a data driver for providing data voltages to the data lines, a gamma reference voltage generator for providing a gamma reference voltage to the data driver, and a driving controller for controlling the gate driver, the emission driver, the data driver, and the gamma reference voltage generator.

The data driver may generate the data voltage based on the gamma reference voltage and a data signal. In addition, the driving controller may determine a target gamma reference voltage corresponding to a target luminance. The gamma reference voltage generator may generate an output gamma reference voltage based on the target gamma reference voltage and may output the output gamma reference voltage.

### SUMMARY

In a display device, a deviation between the target gamma reference voltage and the output gamma reference voltage may occur due to changes in the characteristics of resistors and amplifiers included in the gamma reference voltage generator. When the deviation occur between the target gamma reference voltage and the output gamma reference voltage, the pixels may not accurately emit a light at the target luminance.

Embodiments of the invention provide a display device having improved display quality.

Embodiments of the invention provide a method of operating the display device.

Embodiments of the invention provide an electronic device including the display device.

In an embodiment of a display device according to the invention, the display device includes a display panel including pixels, a gate driver which outputs a gate signal to the pixels, a data driver which outputs a data voltage to the pixels, a gamma reference voltage generator which outputs an output gamma reference voltage to the data driver, and a driving controller which controls the gate driver, the data driver, and the gamma reference voltage generator. In such an embodiment, the driving controller includes a voltage level determiner which determines a target gamma reference voltage corresponding to a target luminance and a voltage compensation level determiner which determines an offset voltage to compensate for a deviation between a first output gamma reference voltage and the target gamma reference voltage, where the first output gamma reference voltage is the output gamma reference voltage prior to compensation thereof, and the gamma reference voltage generator outputs a second output gamma reference voltage, which is obtained by applying the offset voltage to the first output gamma reference voltage, as the output gamma reference voltage.

In an embodiment, the voltage compensation level determiner may include a voltage comparator which determines the deviation between the first output gamma reference voltage and the target gamma reference voltage and an offset voltage determiner which determines the offset voltage to compensate for the deviation.

In an embodiment, the voltage comparator may include a first voltage comparator which determines a first deviation between the first output gamma reference voltage and the target gamma reference voltage based on a first determination criterion and a second voltage comparator which determines a second deviation between the first output gamma reference voltage and the target gamma reference voltage based on a second determination criterion.

In an embodiment, the gamma reference voltage generator may include amplifiers and resistors, and the first voltage comparator may determine the first deviation due to changes in characteristics of the amplifiers.

In an embodiment, the gamma reference voltage generator may include amplifiers and resistors, and the second voltage comparator may determine the second deviation due to voltage drops caused by the resistors.

In an embodiment, the offset voltage determiner may include a first offset voltage determiner which determines a first offset voltage based on the first deviation and a second offset voltage determiner which determines a second offset voltage based on the second deviation.

In an embodiment, when the first output gamma reference voltage is greater than the target gamma reference voltage, the first offset voltage may be less than the target gamma reference voltage, and when the first output gamma reference voltage is less than the target gamma reference voltage, the first offset voltage may be greater than the target gamma reference voltage.

In an embodiment, a deviation between the target gamma reference voltage and the first offset voltage may be equal to the first deviation.

In an embodiment, when the first output gamma reference voltage is greater than the target gamma reference voltage, the second offset voltage may be less than the target gamma reference voltage, and when the first output gamma reference voltage is less than the target gamma reference voltage, the second offset voltage may be greater than the target gamma reference voltage.

In an embodiment, a deviation between the target gamma reference voltage and the second offset voltage may be equal to the second deviation.

In an embodiment of a method of operating a display device according to the invention, the method includes determining a target gamma reference voltage corresponding to a target luminance, comparing a first output gamma reference voltage, which is an output gamma reference voltage output from a gamma reference voltage generator prior to compensation for generating a data voltage corresponding to the target luminance, with the target gamma reference voltage, determining an offset voltage to compensate for a deviation between the first output gamma reference voltage and the target gamma reference voltage, and determining a second output gamma reference voltage by applying the offset voltage to the first output gamma reference voltage.

In an embodiment, the comparing the first output gamma reference voltage output from the gamma reference voltage generator for generating the data voltage corresponding to the target luminance, with the target gamma reference voltage may include determining a first deviation between the first output gamma reference voltage and the target gamma reference voltage based on a first determination criterion and determining a second deviation between the first output gamma reference voltage and the target gamma reference voltage based on a second determination criterion.

In an embodiment, the determining the offset voltage to compensate for the deviation between the first output gamma reference voltage and the target gamma reference voltage may include determining a first offset voltage based on the first deviation and determining a second offset voltage based on the second deviation.

In an embodiment, in the determining the first offset voltage based on the first deviation, when the first output gamma reference voltage is greater than the target gamma reference voltage, the first offset voltage may be less than the target gamma reference voltage, and in the determining the first offset voltage based on the first deviation, when the first output gamma reference voltage is less than the target gamma reference voltage, the first offset voltage may be greater than the target gamma reference voltage.

In an embodiment, a deviation between the target gamma reference voltage and the first offset voltage may be equal to the first deviation.

In an embodiment, in the determining the second offset voltage based on the second deviation, when the first output gamma reference voltage is greater than the target gamma reference voltage, the second offset voltage may be less than the target gamma reference voltage and in the determining the second offset voltage based on the second deviation, when the first output gamma reference voltage is less than the target gamma reference voltage, the second offset voltage may be greater than the target gamma reference voltage.

In an embodiment, a deviation between the target gamma reference voltage and the second offset voltage may be equal to the second deviation.

In an embodiment of an electronic device according to the invention, the electronic device includes a processor which outputs an input control signal and input image data, a display panel including pixels, a gate driver which outputs a gate signal to the pixels, a data driver which outputs a data voltage to the pixels, a gamma reference voltage generator which outputs an output gamma reference voltage to the data driver, and a driving controller which controls the gate driver, the data driver, and the gamma reference voltage generator based on the input control signal and the input image data. In such an embodiment, the driving controller determines a target gamma reference voltage corresponding to a target luminance and determines an offset voltage to compensate for a deviation between a first output gamma reference voltage and the target gamma reference voltage, where the first output gamma reference voltage is the output gamma reference voltage prior to compensation thereof, and the gamma reference voltage generator outputs a second output gamma reference voltage, which is obtained by applying the offset voltage to the first output gamma reference voltage, as the output gamma reference voltage.

In an embodiment, the driving controller may determine a first deviation between the first output gamma reference voltage and the target gamma reference voltage based on a first determination criterion and determine a first offset voltage to compensate for the first deviation.

In an embodiment, the driving controller may determine a second deviation between the first output gamma reference voltage and the target gamma reference voltage based on a second determination criterion and determine a second offset voltage to compensate for the second deviation.

According to embodiments of the display device, the method of operating the display device and the electronic device, the driving controller of the display device may determine the target gamma reference voltage corresponding to the target luminance. When a deviation occurs between an output gamma reference voltage output from the gamma reference voltage generator of the display device and the target gamma reference voltage, the driving controller may determine the first offset voltage and/or the second offset voltage. The gamma reference voltage generator may generate the output gamma reference voltage to which the first offset voltage and/or the second offset voltage are/is applied.

The first offset voltage and/or the second offset voltage are/is applied to the output gamma reference voltage so that the first deviation and/or the second deviation may be decreased. Accordingly, the output gamma reference voltage may be equal to the target gamma reference voltage. That is, the gamma reference voltage generator may accurately generate the output gamma reference voltage corresponding to the target luminance and output the output gamma reference voltage to the data driver of the display device. The data driver may accurately generate a data voltage corresponding to the target luminance and pixels may accurately emit a light at the target luminance such that display quality of the display device may be improved.

In addition, the gamma reference voltage generator generates the output gamma reference voltage which is equal to the target gamma reference voltage so that reliability of the gamma reference voltage generator may be improved. Accordingly, reliability of the display device may be improved.

### BRIEF DESCRIPTION OF THE DRAWINGS

The above and other features of embodiments the invention will become more apparent by describing in detailed embodiments thereof with reference to the accompanying drawings, in which:

FIG. 1 is a block diagram illustrating a display device according to embodiments of the invention;

FIG. 2 is a circuit diagram illustrating an embodiment of a gamma reference voltage generator of FIG. 1;

FIG. 3 is a graph illustrating a data signal according to a luminance;

FIG. 4 is a block diagram illustrating an embodiment of a driving controller of FIG. 1;

FIG. 5 is a block diagram illustrating an embodiment of a voltage compensation level determiner of FIG. 4;

FIG. 6 is a graph illustrating voltages corresponding to gamma nodes of the gamma reference voltage generator of FIG. 1 according to a first determination criterion;

FIG. 7 is a graph illustrating voltages corresponding to gamma nodes of the gamma reference voltage generator of FIG. 1 according to a second determination criterion;

FIG. 8 is a circuit diagram illustrating an embodiment of a pixel of FIG. 1;

FIG. 9 is a flow chart illustrating an embodiment of a method of operating the display device of FIG. 1;

FIG. 10 is a block diagram illustrating an electronic device according to embodiments of the invention; and

FIG. 11 is a diagram illustrating an embodiment in which the electronic device of FIG. 10 is implemented as a smart phone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, display devices in accordance with embodiments will be described in more detail with reference to the accompanying drawings. The same reference numerals are used for the same components in the drawings, and any repetitive detailed descriptions of the same components will be omitted.

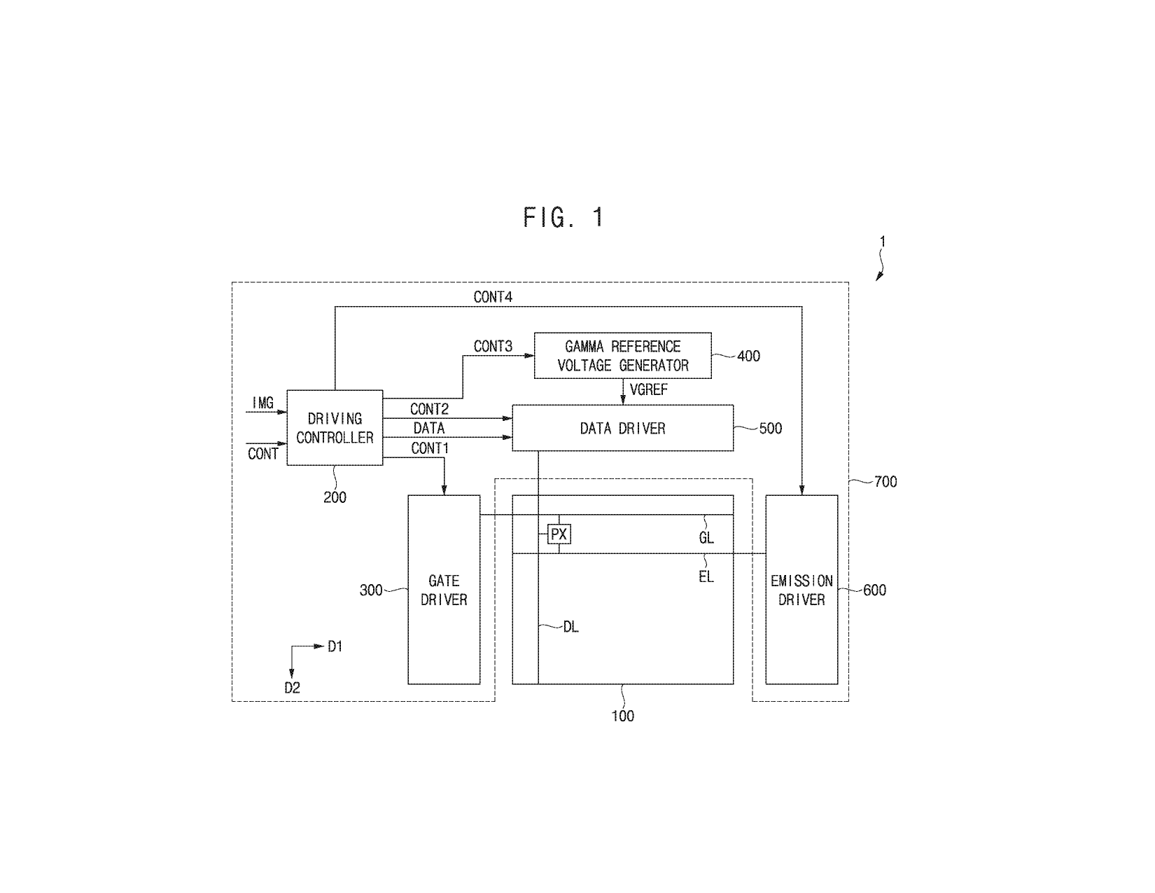

FIG. 1 is a block diagram illustrating a display device 1 according to embodiments of the invention.

Referring to FIG. 1, an embodiment of the display device 1 may include a display panel 100 and a display panel driver 700. The display panel driver 700 may include a driving controller 200, a gate driver 300, a gamma reference voltage generator 400, a data driver 500, and an emission driver 600.

The display panel 100 may include a display region on which an image is displayed and a peripheral region adjacent to the display region.

The display panel 100 may include a plurality of gate lines GL, a plurality of data lines DL, a plurality of emission lines EL, and a plurality of pixels PX electrically connected to the gate lines GL, the data lines DL, and the emission lines EL. The gate lines GL may extend in a first direction D1, the data lines DL may extend in a second direction D2 crossing the first direction D1, and the emission lines EL may extend in the first direction D1.

The driving controller 200 may receive input image data IMG and an input control signal CONT from an external device (e.g. a processor). In an embodiment, for example, the input image data IMG may include red image data, green image data and blue image data. In some embodiments, the input image data IMG may further include white image data. In other embodiments, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and may output the third control signal CONT3 to the gamma reference voltage generator 400.

The driving controller 200 may generate the fourth control signal CONT4 for controlling an operation of the emission driver 600 based on the input control signal CONT, and may output the fourth control signal CONT4 to the emission driver 600.

The gate driver 300 may generate gate signals transmitted to the pixels PX through the gate lines GL in response to the first control signal CONT1 received from the driving controller 200. The gate driver 300 may output the gate signals to the gate lines GL. For example, the gate signals may include a writing gate signal, a compensation gate signal, and an initialization gate signal.

In an embodiment, the gate driver 300 may be integrated on the peripheral region of the display panel 100. In an embodiment, the gate driver 300 may be mounted on the peripheral region of the display panel 100.

The gamma reference voltage generator 400 may generate an output gamma reference voltage VGREF in response to the third control signal CONT3 received from the driving controller 200. The gamma reference voltage generator 400 may output the output gamma reference voltage VGREF to the data driver 500.

In an embodiment, the gamma reference voltage generator 400 may be disposed in the driving controller 200 or in the data driver 500.

The data driver 500 may receive the second control signal CONT2 and the data signal DATA from the driving controller 200 and may receive the output gamma reference voltages VGREF from the gamma reference voltage generator 400. The data driver 500 may convert the data signal DATA having a digital type into data voltages having an analog type using the output gamma reference voltages VGREF. The data driver 500 may output the data voltages to the data lines DL.

In an embodiment, the data driver 500 may be integrated on the peripheral region of the display panel 100. In an embodiment, the data driver 500 may be mounted on the peripheral region of the display panel 100.

The emission driver 600 may generate emission signals transmitted to the pixels PX through the emission lines EL in response to the fourth control signal CONT4 received from the driving controller 200. The emission driver 600 may output the emission signals to the emission lines EL.

In an embodiment, the emission driver 600 may be integrated on the peripheral region of the display panel 100. In an embodiment, the emission driver 600 may be mounted on the peripheral region of the display panel 100.

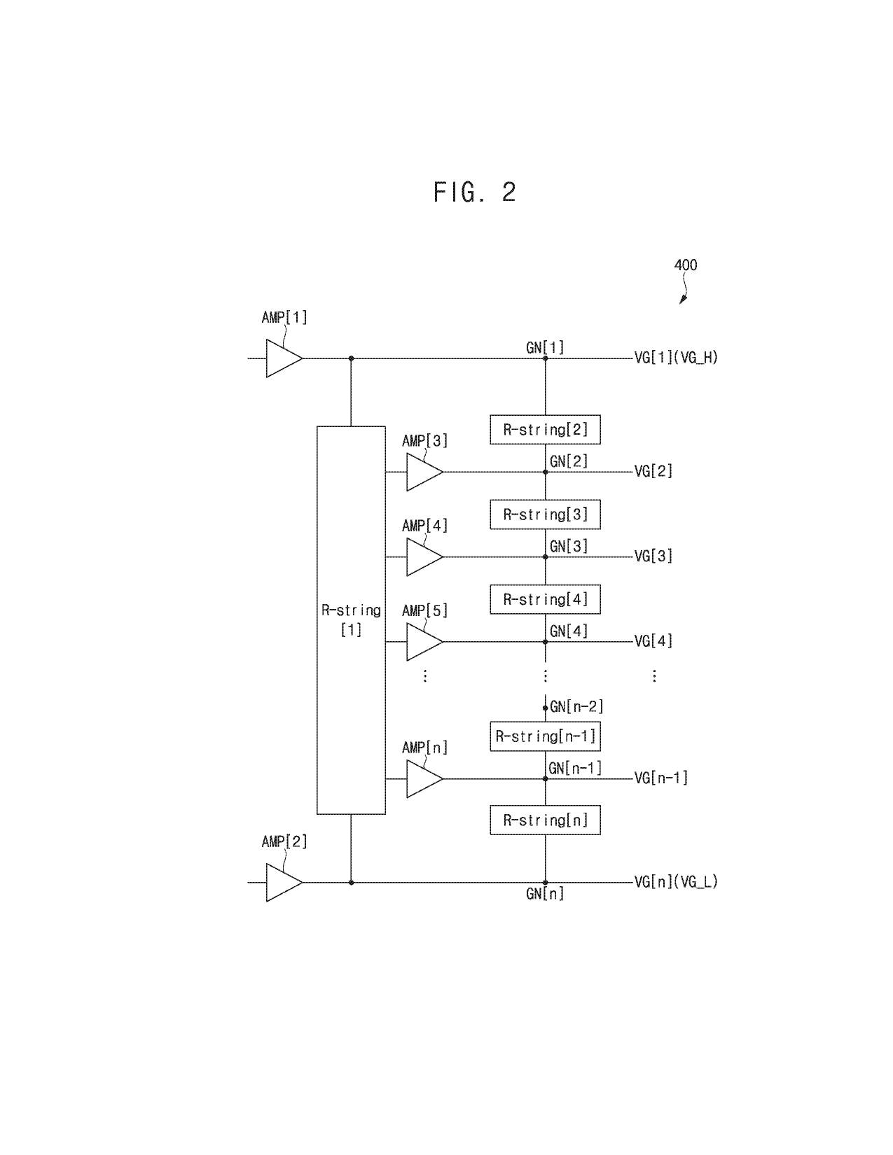

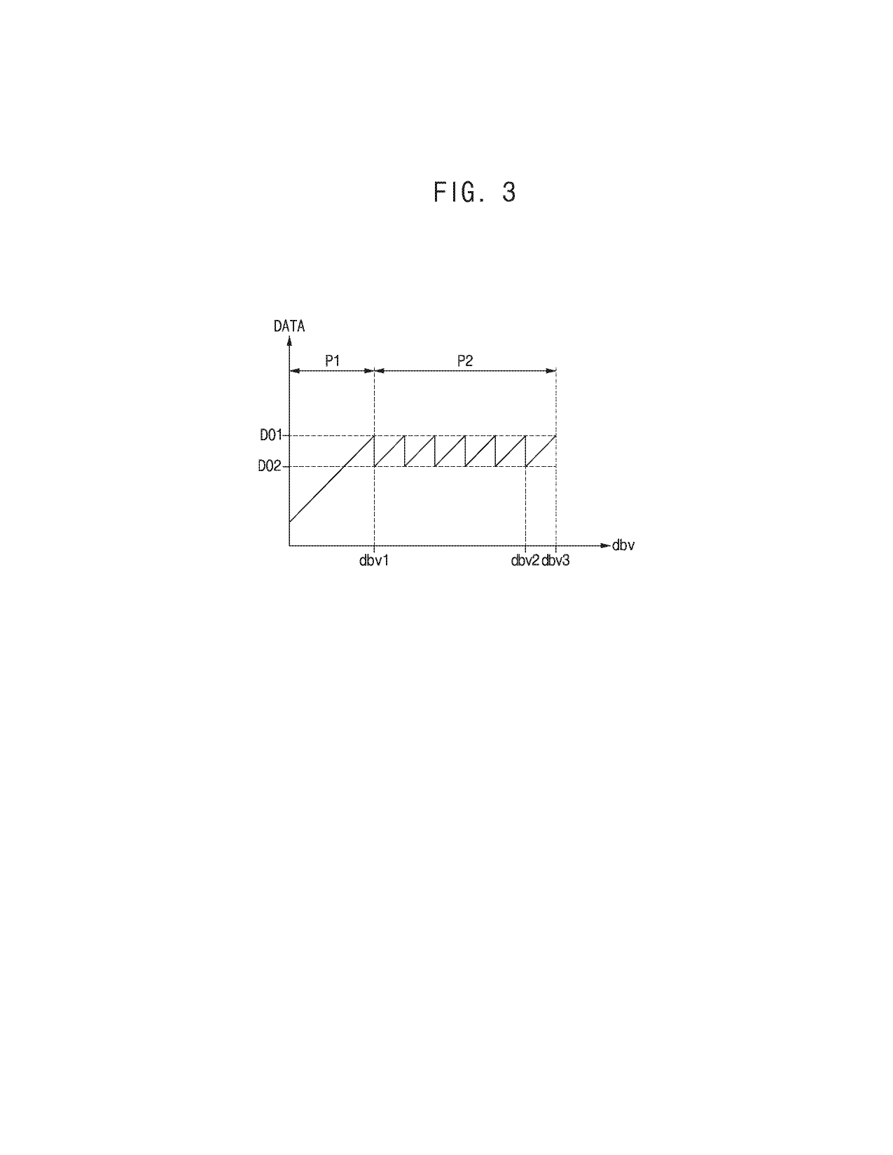

FIG. 2 is a circuit diagram illustrating an embodiment of the gamma reference voltage generator 400 of FIG. 1. FIG. 3 is a graph illustrating the data signal DATA according to a luminance.

Referring to FIG. 2, an embodiment of the gamma reference voltage generator 400 may include amplifiers AMP[1] to AMP[n] and resistor strings R-string[1] to R-string[n], where n is an integer greater than or equal to 2, but the gamma reference voltage generator 400 is not limited thereto. Each of the resistor strings R-string[1] to R-string[n] may include resistors. For convenience of description, embodiments where the gamma reference voltage generator 400 includes a first amplifier AMP[1] to an n-th amplifier AMP[n] and a first resistor string R-string [1] to an n-th resistor string R-string[n] will hereinafter be described in detail.

The first amplifier AMP[1] may output a first gamma reference voltage VG[1]. The first gamma reference voltage VG[1] may be a high gamma reference voltage VG_H. In addition, the second amplifier AMP[2] may output an n-th gamma reference voltage VG[n]. The n-th gamma reference voltage VG[n] may be a low gamma reference voltage VG_L.

A first gamma node GN[1] may have the first gamma reference voltage VG[1] and an n-th gamma node GN[n] may have the n-th gamma reference voltage VG[n].

The first gamma reference voltage VG[1] and the n-th gamma reference voltage VG[n] may be divided into n voltages. In an embodiment, for example, the third amplifier AMP[3] may output a second gamma reference voltage VG[2] and a second gamma node GN[2] may have the second gamma reference voltage VG[2]. The fourth amplifier AMP[4] may output a third gamma reference voltage VG[3] and a third gamma node GN[3] may have the third gamma reference voltage VG[3]. The fifth amplifier AMP[5] may output a fourth gamma reference voltage VG[4] and the fourth gamma node GN[4] may have the fourth gamma reference voltage VG[4]. In such an embodiment, the n-th amplifier AMP[n] may output an (n-1)-th gamma reference voltage VG[n-1] and an (n-1)-th gamma node GN[n-1] may have the (n-1)-th gamma reference voltage VG[n-1].

The first gamma node GN[1] to the n-th gamma node GN[n] may be connected by the second resistor string R-string[2] to the n-th resistor string R-string[n]. In an embodiment, for example, the first gamma node GN[1] may be connected to the second gamma node GN[2] through the second resistor string R-string[2], the second gamma node GN[2] may be connected to the third gamma node GN[3] through the third resistor string R-string[3]. In such an embodiment, the (n-1)-th gamma node GN[n-1] may be connected to the n-th gamma node GN[n] through the n-th resistor string R-string[n].

In addition, the gamma nodes GN[1] to GN[n] may be divided into gamma sub nodes by the second resistor string R-string[2] to the n-th resistor string R-string[n].

The output gamma reference voltage VGREF may include the first gamma reference voltage VG[1] to the n-th gamma reference voltage VG[n]. The output gamma reference voltage VGREF may be an analog voltage.

Referring to FIG. 3, a luminance dbv is lower than a first luminance dbv1 in a first range P1 and the luminance dbv is higher than the first luminance dbv1 in a second range P2.

The display device 1 may adjust an emission duty of the emission signal to control the luminance dbv in the first range P1. The data signal DATA may be decreased as the luminance dbv is decreased in the first range P1.

In addition, the display device 1 may maintain the emission duty of the emission signal and adjust the output gamma reference voltage VGREF to control the luminance dbv in the second range P2. The data signal DATA corresponding to the luminance dbv may maintain a constant data in the second range P2. In an embodiment, for example, when the luminance dbv decreases from a third luminance dbv3 to a second luminance dbv2 in the second range P2, loss of the data signal DATA may occur. That is, when the luminance dbv decreases from a third luminance dbv3 to a second luminance dbv2 in the second range P2, the data signal DATA may be decreased from a first data signal DO1 to a second data signal DO2. The driving controller 200 may increase the n-th gamma reference voltage VG[n] to increase the data signal DATA from the second data signal DO2 back to the first data signal DO1. The data signal DATA may be increased from the second data signal DO2 back to the first data signal DO1.

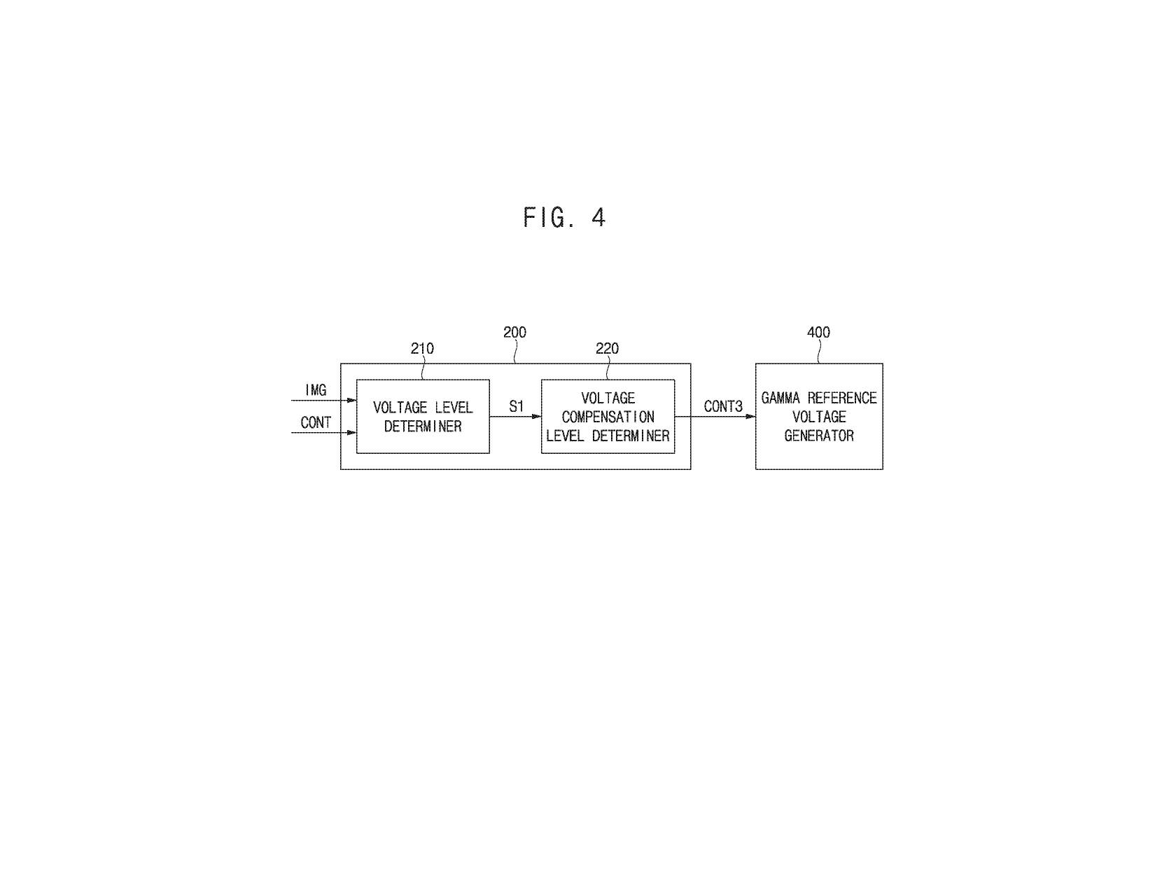

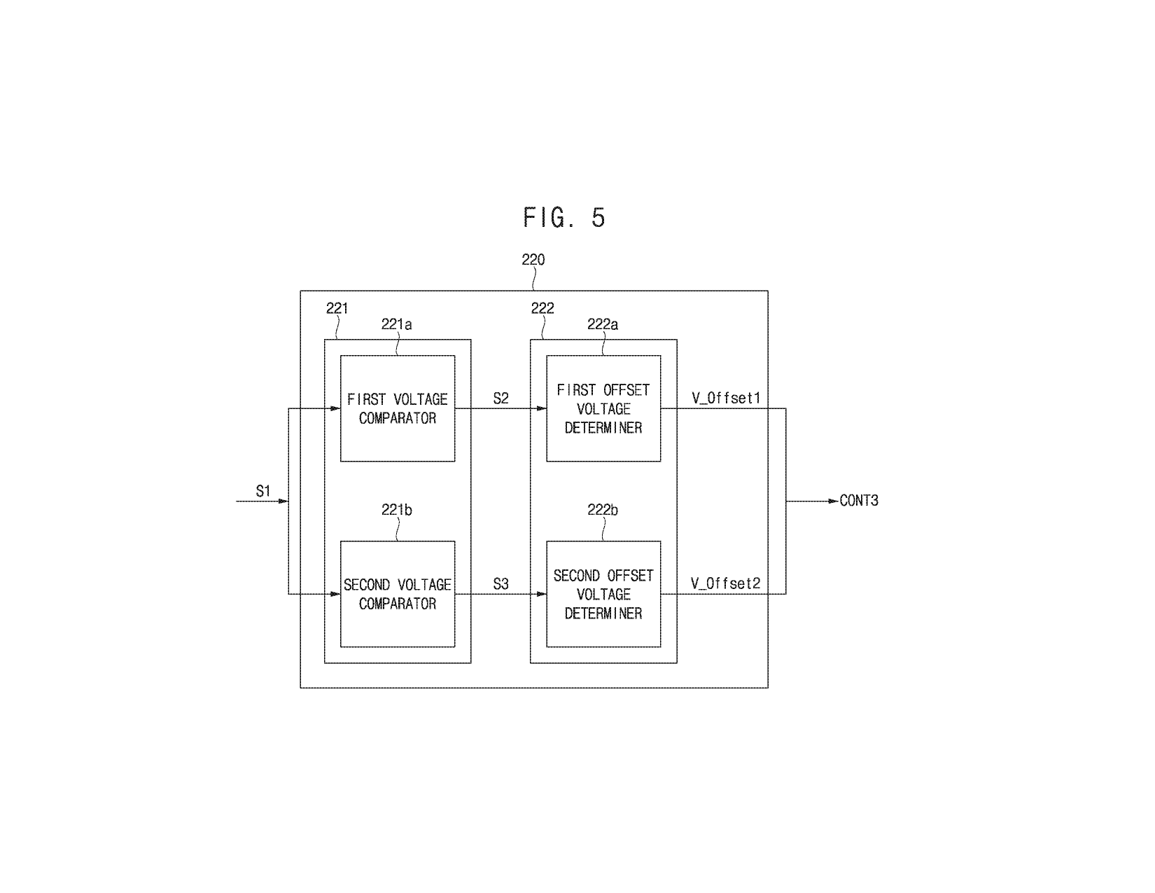

FIG. 4 is a block diagram illustrating an embodiment of the driving controller 200 of FIG. 1. FIG. 5 is a block diagram illustrating an embodiment of a voltage compensation level determiner 220 of FIG. 4.

Referring to FIG. 4, an embodiment of the driving controller 200 may include a voltage level determiner 210 and the voltage compensation level determiner 220.

The voltage level determiner 210 may determine a target gamma reference voltage corresponding to a target luminance based on the input image data IMG and the input control signal CONT. The gamma reference voltage generator 400 may generate the output gamma reference voltage VGREF based on the target gamma reference voltage and output the output gamma reference voltage VGREF. The target gamma reference voltage corresponding to the luminance dbv may be stored in a look up table (LUT). In an embodiment, for example, the voltage level determiner 210 may determine the target gamma reference voltage corresponding to the target luminance based on the LUT.

The voltage level determiner 210 may determine the high gamma reference voltage VG_H and the low gamma reference voltage VG_L corresponding to the target luminance based on the LUT. In an embodiment, the high gamma reference voltage VG_H and the low gamma reference voltage VG_L are changed by the voltage level determiner 210 so that the second gamma reference voltage VG[2] to the (n-1)-th gamma reference voltage VG[n-1] may be changed.

In an embodiment, for example, when the luminance dbv is the third luminance dbv3, the voltage level determiner 210 may determine a level of the high gamma reference voltage VG_H as a first high level and determine a level of the low gamma reference voltage VG_L as a first low level. When the luminance dbv decreases from the third luminance dbv3 to the second luminance dbv2, the voltage level determiner 210 may determine the level of the high gamma reference voltage VG_H as the first high level and determine the level of the low gamma reference voltage VG_L as a second low level higher than the first low level.

The voltage level determiner 210 may output a first voltage control signal S1 including information for the target gamma reference voltage to the voltage compensation level determiner 220.

The voltage compensation level determiner 220 may generate the third control signal CONT3 based on the first voltage control signal S1.

Referring to FIG. 5, an embodiment of the voltage compensation level determiner 220 may include a voltage comparator 221 and an offset voltage determiner 222.

The output gamma reference voltage VGREF output to the data driver 500 may be different from the target gamma reference voltage determined by the voltage level determiner 210. That is, a deviation between the target gamma reference voltage determined by the voltage level determiner 210 to cause the pixel PX to emit a light at the target luminance and the output gamma reference voltage VGREF actually output by the gamma reference voltage generator 400 to the data driver 500 may occur. A first output gamma reference voltage may be the output gamma reference voltage VGREF prior to compensation of the deviation. That is, the output gamma reference voltage VGREF having the deviation may be the first output gamma reference voltage.

In an embodiment, the deviation may be caused by changes in characteristics of the amplifiers AMP[1] to AMP[n] included in the gamma reference voltage generator 400. In addition, the deviation may be caused by voltage drops caused by the resistors.

The voltage compensation level determiner 220 may determine a compensation level for a first deviation due to the changes in the characteristics of the amplifiers AMP[1] to AMP[n] and a second deviation due to the voltage drops caused by the resistors.

The voltage comparator 221 may include a first voltage comparator 221a and a second voltage comparator 221b. In addition, the offset voltage determiner 222 may include a first offset voltage determiner 222a and a second offset voltage determiner 222b.

The first voltage comparator 221a may determine the first deviation based on a first determination criterion. The first voltage comparator 221a may compare the target gamma reference voltage and the first output gamma reference voltage, determine a difference between the target gamma reference voltage and the first output gamma reference voltage due to the changes in the characteristics of the amplifiers AMP[1] to AMP[n] included in the gamma reference voltage generator 400, and determine the first deviation which is the difference between the target gamma reference voltage and the first output gamma reference voltage.

The first voltage comparator 221a may generate a second voltage control signal S2 including information for the first deviation.

The second voltage comparator 221b may determine the second deviation based on a second determination criterion. The second voltage comparator 221b may compare the target gamma reference voltage and the first output gamma reference voltage, determine a difference between the target gamma reference voltage and the first output gamma reference voltage due to the voltage drops caused by the resistors included in the gamma reference voltage generator 400, and determine the second deviation which is the difference between the target gamma reference voltage and the first output gamma reference voltage.

The second voltage comparator 221b may generate a third voltage control signal S3 including information for the second deviation.

The first offset voltage determiner 222a may determine a first offset voltage V_Offset1 to compensate for the first deviation based on the second voltage control signal S2.

The second offset voltage determiner 222b may determine a second offset voltage V_Offset2 to compensate for the second deviation based on the third voltage control signal S3.

The third control signal CONT3 may include information for the first offset voltage V_Offset1 and the second offset voltage V_Offset2. In addition, the third control signal CONT3 may include the information for the target gamma reference voltage.

The gamma reference voltage generator 400 may generate a second output gamma reference voltage based on the third control signal CONT3. The second output gamma reference voltage may be the first output gamma reference voltage to which the first offset voltage V_Offset1 and/or the second offset voltage V_Offset2 are/is applied.

The first offset voltage V_Offset1 and/or the second offset voltage V_Offset2 are/is applied to the output gamma reference voltage VGREF so that the first deviation and/or the second deviation may be decreased. Accordingly, the output gamma reference voltage VGREF may be equal to the target gamma reference voltage. That is, the gamma reference voltage generator 400 may accurately generate the output gamma reference voltage VGREF corresponding to the target luminance and output the output gamma reference voltage VGREF to the data driver 500. The data driver 500 may accurately generate the data voltage corresponding to the target luminance and the pixels PX may accurately emit a light at the target luminance.

The pixels PX accurately emit a light at the target luminance so that display quality of the display device 1 may be improved.

In addition, the gamma reference voltage generator 400 generates the output gamma reference voltage VGREF which is equal to the target gamma reference voltage so that reliability of the gamma reference voltage generator 400 may be improved. Accordingly, reliability of the display device 1 may be improved.

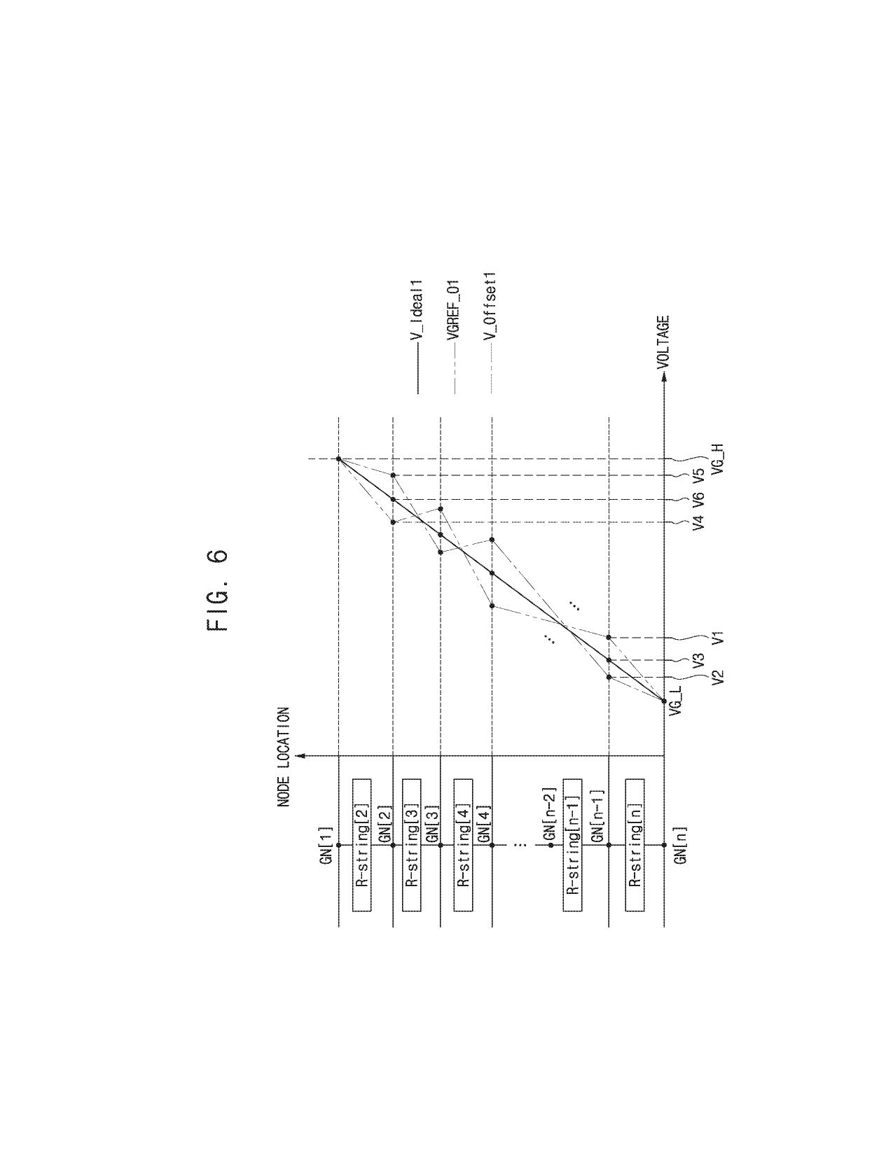

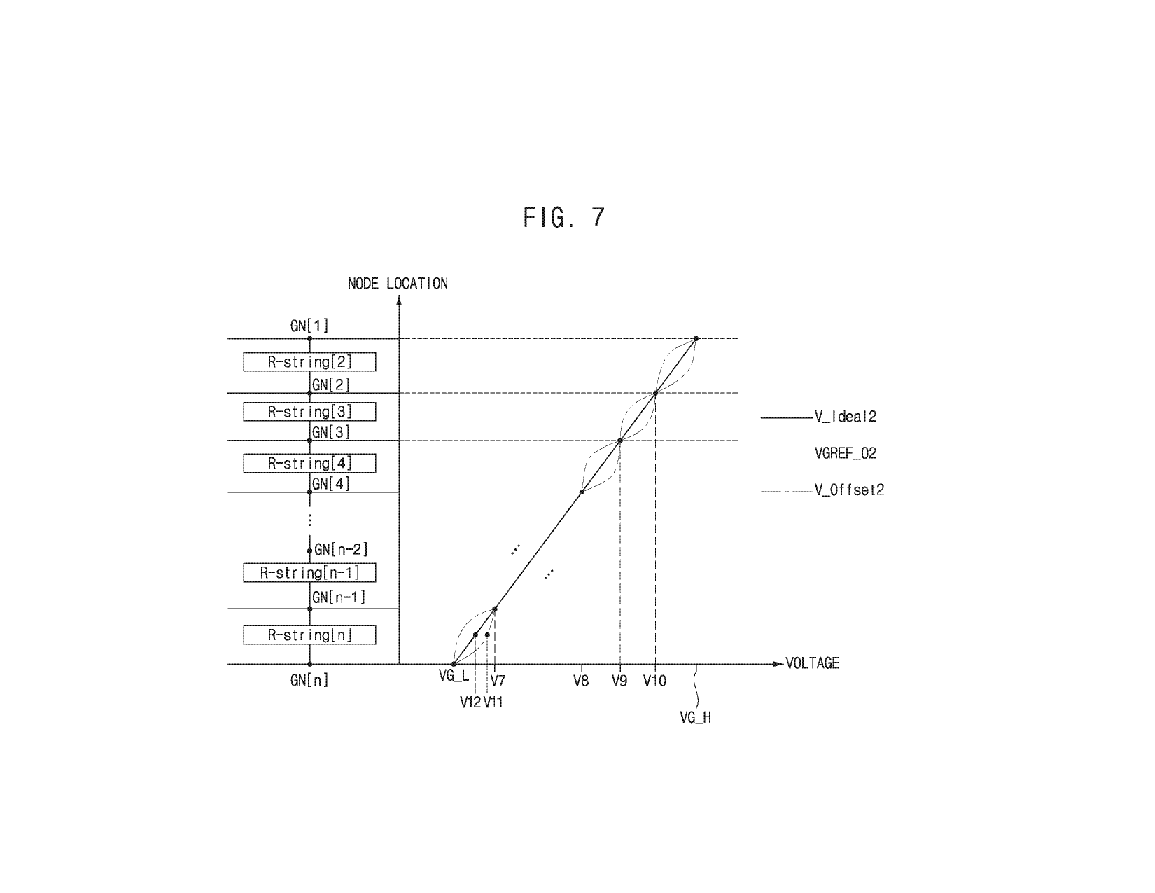

FIG. 6 is a graph illustrating voltages corresponding to the gamma nodes GN[1] to GN[n] of the gamma reference voltage generator 400 of FIG. 1 according to the first determination criterion. FIG. 7 is a graph illustrating voltages corresponding to the gamma nodes GN[1] to GN[n] of the gamma reference voltage generator 400 of FIG. 1 according to the second determination criterion.

Referring to FIG. 6, a first target gamma reference voltage V_Ideal1 may be the target gamma reference voltage according to the first determination criterion. A first sub output gamma reference voltage VGREF_O1 may be the first output gamma reference voltage having the first deviation. The first offset voltage V_Offset1 may be a compensation value to compensate for the first deviation.

The driving controller 200 may output the first offset voltage V_Offset1 to the gamma reference voltage generator 400 to decrease the first deviation and the gamma reference voltage generator 400 may generate the second output gamma reference voltage which is equal to the first target gamma reference voltage V_Ideal1 by applying the first offset voltage V_Offset1 to the first sub output gamma reference voltage VGREF_O1 to decrease the first deviation.

In an embodiment, for example, the first sub output gamma reference voltage VGREF_O1 may be a first voltage V1 and the first offset voltage V_Offset1 may be a second voltage V2 at the (n-1)-th gamma node GN[n-1]. The first target gamma reference voltage V_Ideal1 may be a third voltage V3 at the (n-1)-th gamma node GN[n-1]. The first voltage V1 may be greater than the third voltage V3. That is, the first deviation a difference between the first voltage V1 and the third voltage V3. The first offset voltage V_Offset1 may be less than the first target gamma reference voltage V_Ideal1 to compensate for the first deviation. That is, the second voltage V2 may be less than the third voltage V3. In addition, a difference between third voltage V3 and the second voltage V2 may be equal to the difference between the first voltage V1 and the third voltage V3. That is, the driving controller 200 may determine the first offset voltage V_Offset1 having the second voltage V2 and the gamma reference voltage generator 400 may generate the second output gamma reference voltage having the third voltage V3 by applying the first offset voltage V_Offset1 to the first sub output gamma reference voltage VGREF_O1.

In an embodiment, for example, the first sub output gamma reference voltage VGREF_O1 may be a fourth voltage V4 and the first offset voltage V_Offset1 may be a fifth voltage V5 at the second gamma node GN[2]. The first target gamma reference voltage V_Ideal1 may be a sixth voltage V6 at the second gamma node GN[2]. The fourth voltage V4 may be less than the sixth voltage V6. That is, the first deviation a difference between the sixth voltage V6 and the fourth voltage V4. The first offset voltage V_Offset1 may be greater than the first target gamma reference voltage V_Ideal1 to compensate for the first deviation. That is, the fifth voltage V5 may be greater than the sixth voltage V6. In addition, a difference between the fifth voltage V5 and the sixth voltage V6 may be equal to the difference between the sixth voltage V6 and the fourth voltage V4. That is, the driving controller 200 may determine the first offset voltage V_Offset1 having the fifth voltage V5 and the gamma reference voltage generator 400 may generate the second output gamma reference voltage having the sixth voltage V6 by applying the first offset voltage V_Offset1 to the first sub output gamma reference voltage VGREF_O1.

Referring to FIG. 7, a second target gamma reference voltage V_Ideal2 may be the target gamma reference voltage according to the second determination criterion. A second sub output gamma reference voltage VGREF_O2 may be the first output gamma reference voltage having the second deviation. The second offset voltage V_Offset2 may be a compensation value to compensate for the second deviation.

The driving controller 200 may output the second offset voltage V_Offset2 to the gamma reference voltage generator 400 to decrease the second deviation and the gamma reference voltage generator 400 may generate the second output gamma reference voltage which is equal to the second target gamma reference voltage V_Ideal2 by applying the second offset voltage V_Offset2 to the second sub output gamma reference voltage VGREF_O2 to decrease the second deviation.

In an embodiment, the second target gamma reference voltage V_Ideal2 may be equal to the second sub output gamma reference voltage VGREF_O2 at the gamma nodes GN[1] to GN[n]. That is, the second deviation may be zero (0) at the each of the gamma nodes GN[1] to GN[n]. In an embodiment, for example, the second target gamma reference voltage V_Ideal2 of the (n-1)-th gamma node GN[n-1] may be a seventh voltage V7 and the second sub output gamma reference voltage VGREF_O2 may be the seventh voltage V7. For example, the second target gamma reference voltage V_Ideal2 of the fourth gamma node GN[4] may be an eighth voltage V8 and the second sub output gamma reference voltage VGREF_O2 may be the eighth voltage V8. In an embodiment, for example, the second target gamma reference voltage V_Ideal2 of the third gamma node GN[3] may be a ninth voltage V9 and the second sub output gamma reference voltage VGREF_O2 may be the ninth voltage V9. In an embodiment, for example, the second target gamma reference voltage V_Ideal2 of the second gamma node GN[2] may be a tenth voltage V10 and the second sub output gamma reference voltage VGREF_O2 may be the tenth voltage V10.

The second sub output gamma reference voltage VGREF_O2 may be greater than the second target gamma reference voltage V_Ideal2 at the gamma sub nodes located between each of the gamma nodes GN[1] to GN[n]. In an embodiment, for example, the second sub output gamma reference voltage VGREF_O2 of a first gamma sub node between the n-th gamma node GN[n] and the (n-1)-th gamma node GN[n-1] may be an eleventh voltage V11 and the second target gamma reference voltage V_Ideal2 may be a twelfth voltage V12. The eleventh voltage V11 may be greater than the twelfth voltage V12.

The second deviation may be a difference between the second sub output gamma reference voltage VGREF_O2 and the second target gamma reference voltage V_Ideal2. The second offset voltage V_Offset2 may be less than the second target gamma reference voltage V_Ideal2 to compensate for the second deviation. In addition, a deviation between the second target gamma reference voltage V_Ideal2 and the second offset voltage V_Offset2 may be equal to a difference between the second sub output gamma reference voltage VGREF_O2 and the second target gamma reference voltage V_Ideal2. That is, the driving controller 200 may determine the second offset voltage V_Offset2 and the gamma reference voltage generator 400 may generate the second output gamma reference voltage which is equal to the second target gamma reference voltage V_Ideal2 by applying the second offset voltage V_Offset2 to the second sub output gamma reference voltage VGREF_O2.

The driving controller 200 may determine the first offset voltage V_Offset1 and/or the second offset voltage V_Offset2 and the gamma reference voltage generator 400 may generate the output gamma reference voltage VGREF which is equal to the target gamma reference voltage by applying the first offset voltage V_Offset1 and/or the second offset voltage V_Offset2 to the first sub output gamma reference voltage VGREF_O1 and/or the second sub output gamma reference voltage VGREF_O2.

The target gamma reference voltage may include the first target gamma reference voltage V_Ideal1 and the second target gamma reference voltage V_Ideal2. The output gamma reference voltage VGREF may include the first sub output gamma reference voltage VGREF_O1 and the second sub output gamma reference voltage VGREF_O2.

In such an embodiment, the first offset voltage V_Offset1 and/or the second offset voltage V_Offset2 are/is applied to the output gamma reference voltage VGREF so that the first deviation and/or the second deviation may be decreased. Accordingly, the output gamma reference voltage VGREF may be equal to the target gamma reference voltage. That is, the gamma reference voltage generator 400 may accurately generate the output gamma reference voltage VGREF corresponding to the target luminance and output the output gamma reference voltage VGREF to the data driver 500. The data driver 500 may accurately generate the data voltage corresponding to the target luminance and the pixels PX may accurately emit a light at the target luminance.

The pixels PX accurately emit a light at the target luminance so that the display quality of the display device 1 may be improved.

In such an embodiment, the gamma reference voltage generator 400 generates the output gamma reference voltage VGREF which is equal to the target gamma reference voltage so that the reliability of the gamma reference voltage generator 400 may be improved. Accordingly, the reliability of the display device 1 may be improved.

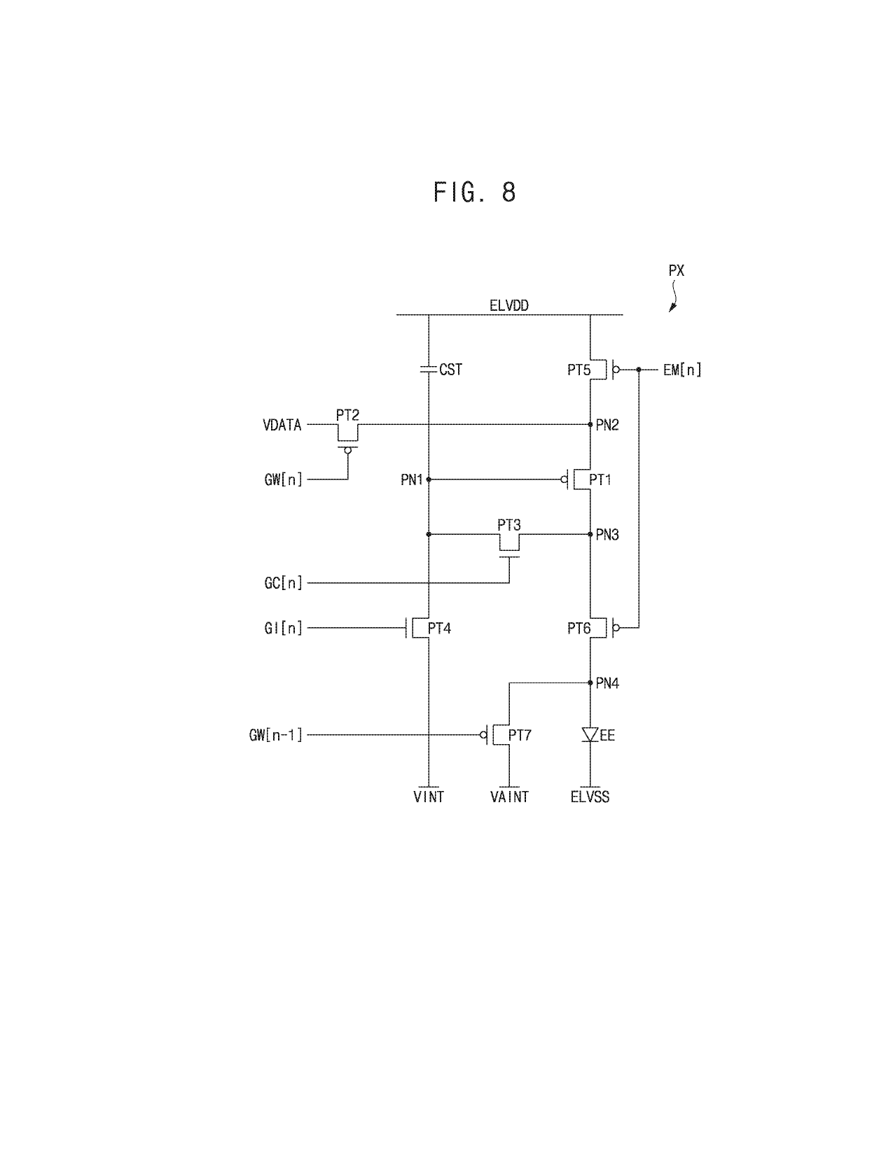

FIG. 8 is a circuit diagram illustrating an embodiment of the pixel PX of FIG. 1.

Referring to FIG. 8, an embodiment of the pixel PX may include a first pixel transistor PT1 to a seventh pixel transistor PT7, a storage capacitor CST, and a light emitting element EE, but the pixel is not limited thereto.

The first pixel transistor PT1 may include a control electrode connected to a first pixel node PN1, a first electrode connected to a second pixel node PN2, and a second electrode connected to a third pixel node PN3. The first pixel transistor PT1 may generate a driving current based on a difference between a voltage of the first pixel node PN1 and a voltage of the second pixel node PN2.

The second pixel transistor PT2 may include a control electrode that receives the writing gate signal GW[n], a first electrode that receives (or connected to receive) the data voltage VDATA, and a second electrode connected to the second pixel node PN2. The second pixel transistor PT2 may transmit the data voltage VDATA to the second pixel node PN2 in response to the writing gate signal GW[n].

The third pixel transistor PT3 may include a control electrode that receives the compensation gate signal GC[n], a first electrode connected to the third pixel node PN3, and a second electrode connected to the first pixel node PN1. The third pixel transistor PT3 may diode-connect the first pixel transistor PT1 in response to the compensation gate signal GC[n].

The fourth pixel transistor PT4 may include a control electrode that receives the initialization gate signal GI[n], a first electrode that receives an initialization voltage VINT, and a second electrode connected to the first pixel node PN1. The fourth pixel transistor PT4 may transmit the initialization voltage VINT to the first pixel node PN1 in response to the initialization gate signal GI[n].

The fifth pixel transistor PT5 may include a control electrode that receives the emission signal EM[n], a first electrode that receives a first pixel power supply voltage ELVDD, and a second electrode connected to the second pixel node PN2.

The sixth pixel transistor PT6 may include a control electrode that receives the emission signal EM[n], a first electrode connected to the third pixel node PN3, and a second electrode connected to a fourth pixel node PN4.

The fifth pixel transistor PT5 and the sixth pixel transistor PT6 may control an light emission of the light emitting element EE in response to the emission signal EM[n].

The seventh pixel transistor PT7 may include a control electrode that receives a previous writing gate signal GW[n-1], a first electrode that receives an anode initialization voltage VAINT, and a second electrode connected to the fourth pixel node PN4. The seventh pixel transistor PT7 may transmit the anode initialization voltage VAINT to the fourth pixel node PN4 in response to the previous writing gate signal GW[n-1].

The storage capacitor CST may include a first electrode that receives the first pixel power supply voltage ELVDD and a second electrode connected to the first pixel node PN1. The storage capacitor CST may store the data voltage VDATA.

The light emitting element EE may include an anode electrode connected to the fourth pixel node PN4 and a cathode electrode that receives a second pixel power supply voltage ELVSS. The light emitting element EE may emit a light based on the driving current generated by the first pixel transistor PT1. A magnitude of the driving current is determined based on the data voltage VDATA so that a light emission intensity of the light emitting element EE may be determined based on the data voltage VDATA.

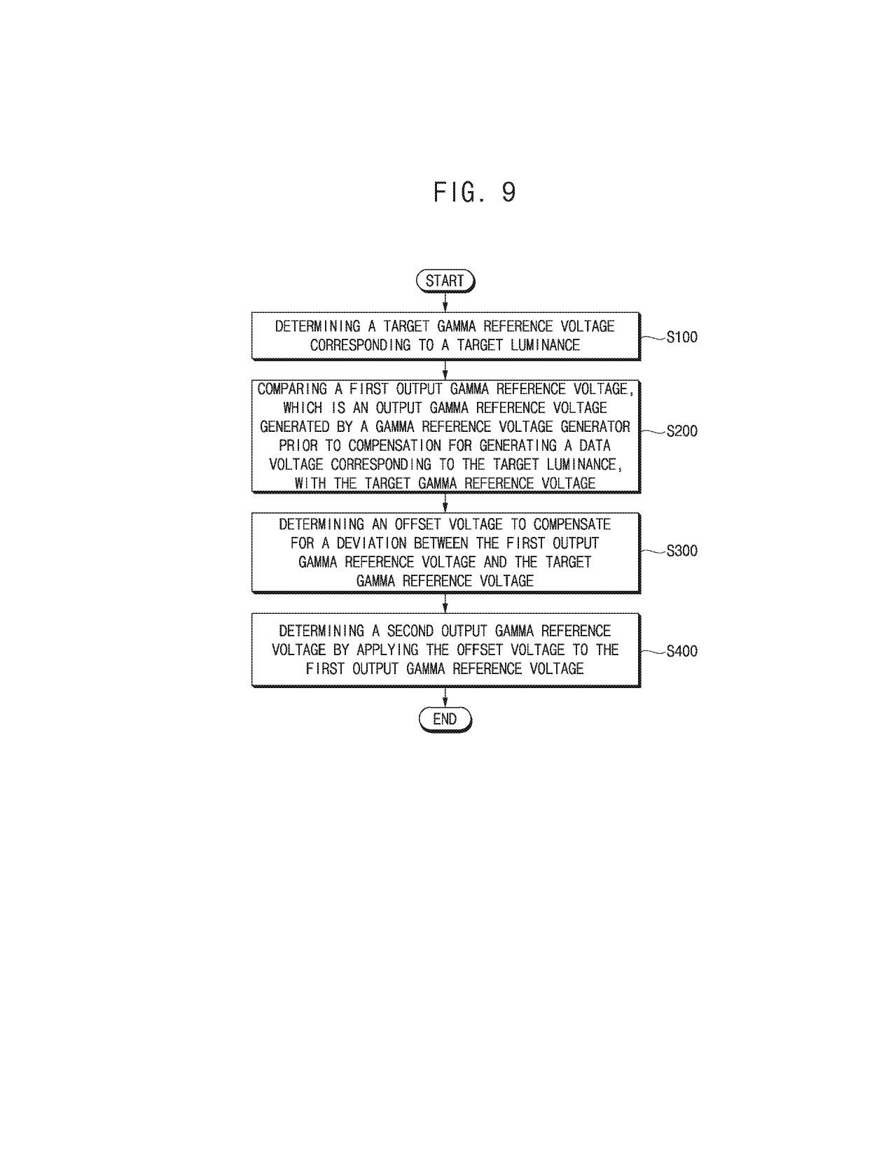

FIG. 9 is a flow chart illustrating an embodiment of a method of operating the display device 1 of FIG. 1.

An embodiment of the method of operating the display device 1 may be operated by the driving controller 200. Accordingly, the same reference numerals will be used to refer to the same or like parts as those described in the previous embodiment of FIGS. 1 to 8 and any repetitive detailed description thereof will be omitted.

Referring to FIGS. 1 to 9, an embodiment of the method of operating the display device 1 may include determining the target gamma reference voltage corresponding to the target luminance (S100), comparing the first output gamma reference voltage, which is the output gamma reference voltage VGREF output from the gamma reference voltage generator 400 prior to compensation for generating the data voltage VDATA corresponding to the target luminance, with the target gamma reference voltage (S200), determining the offset voltage to compensate for the deviation between the first output gamma reference voltage and the target gamma reference voltage (S300), and determining the second output gamma reference voltage by applying the offset voltage to the first output gamma reference voltage (S400).

The comparing the first output gamma reference voltage, which is the output gamma reference voltage VGREF output from the gamma reference voltage generator 400 prior to compensation for generating the data voltage VDATA corresponding to the target luminance, with the target gamma reference voltage S200 may include determining the first deviation between the first output gamma reference voltage and the target gamma reference voltage based on the first determination criterion and determining the second deviation between the first output gamma reference voltage and the target gamma reference voltage based on the second determination criterion.

The determining the offset voltage to compensate for the deviation between the first output gamma reference voltage and the target gamma reference voltage S300 may include determining the first offset voltage V_Offset1 based on the first deviation and determining the second offset voltage V_Offset2 based on the second deviation.

In the determining the first offset voltage V_Offset1 based on the first deviation, the first offset voltage V_Offset1 may be less than the target gamma reference voltage when the first output gamma reference voltage is greater than the target gamma reference voltage. In addition, in the determining the first offset voltage V_Offset1 based on the first deviation, the first offset voltage V_Offset1 may be greater than the target gamma reference voltage when the first output gamma reference voltage is less than the target gamma reference voltage.

A deviation between the target gamma reference voltage and the first offset voltage V_Offset1 may be equal to the first deviation.

In the determining the second offset voltage V_Offset2 based on the second deviation, the second offset voltage V_Offset2 may be less than the target gamma reference voltage when the first output gamma reference voltage is greater than the target gamma reference voltage. In addition, in the determining the second offset voltage V_Offset2 based on the second deviation, the second offset voltage V_Offset2 may be greater than the target gamma reference voltage when the first output gamma reference voltage is less than the target gamma reference voltage.

A deviation between the target gamma reference voltage and the second offset voltage V_Offset2 may be equal to the second deviation.

In the determining the second output gamma reference voltage by applying the offset voltage to the first output gamma reference voltage S400, the driving controller 200 may determine the second output gamma reference voltage which is first output gamma reference voltage to which the first offset voltage V_Offset1 and/or the second offset voltage V_Offset2 is applied. The gamma reference voltage generator 400 may generate the second output gamma reference voltage and output the second output gamma reference voltage.

The driving controller 200 may determine the first offset voltage V_Offset1 and/or the second offset voltage V_Offset2 by the method of operating the display device 1. In addition, the gamma reference voltage generator 400 may generate the output gamma reference voltage VGREF which is equal to the target gamma reference voltage by applying the first offset voltage V_Offset1 and/or the second offset voltage V_Offset2 to the first output gamma reference voltage.

In such an embodiment, the first offset voltage V_Offset1 and/or the second offset voltage V_Offset2 are/is applied to the output gamma reference voltage VGREF so that the first deviation and/or the second deviation may be decreased. Accordingly, the output gamma reference voltage VGREF may be equal to the target gamma reference voltage. That is, the gamma reference voltage generator 400 may accurately generate the output gamma reference voltage VGREF corresponding to the target luminance and output the output gamma reference voltage VGREF to the data driver 500. The data driver 500 may accurately generate the data voltage VDATA corresponding to the target luminance and the pixels PX may accurately emit a light at the target luminance.

The pixels PX accurately emit a light at the target luminance so that the display quality of the display device 1 may be improved.

In such an embodiment, the gamma reference voltage generator 400 generates the output gamma reference voltage VGREF which is equal to the target gamma reference voltage so that the reliability of the gamma reference voltage generator 400 may be improved. Accordingly, the reliability of the display device 1 may be improved.

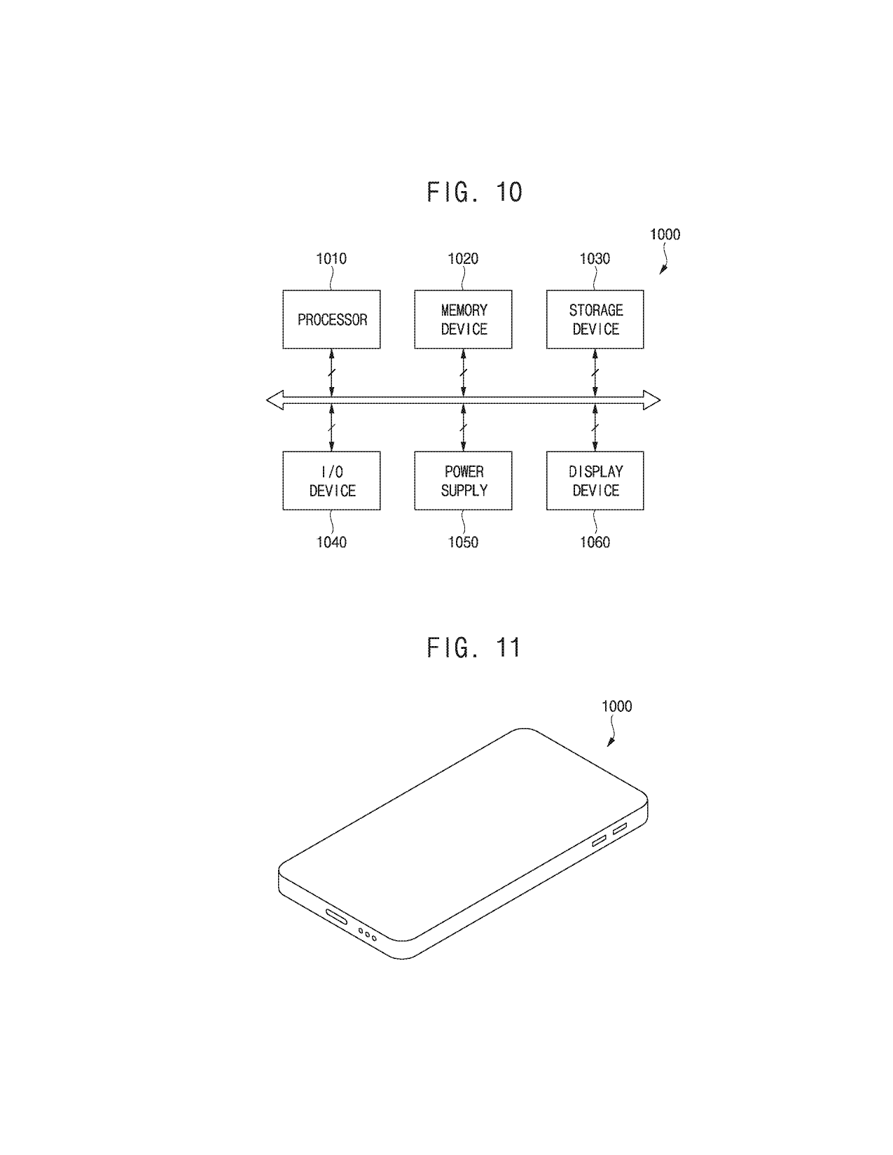

FIG. 10 is a block diagram illustrating an electronic device 1000 according to embodiments of the invention. FIG. 11 is a diagram illustrating an embodiment in which the electronic device 1000 of FIG. 10 is implemented as a smart phone.

Referring to FIGS. 10 and 11, an embodiment of the electronic device 1000 may include a processor 1010, a memory device 1020, a storage device 1030, an input/output (I/O) device 1040, a power supply 1050 and a display device 1060. The display device 1060 may be the display device 1 of FIG. 1. In addition, the electronic device 1000 may further include ports for communicating with a video card, a sound card, a memory card, a universal serial bus (USB) device, other electronic device, and the like.

In an embodiment, as illustrated in FIG. 11, the electronic device 1000 may be implemented as the smart phone. However, the electronic device 1000 is not limited thereto. In an embodiment, for example, the electronic device 1000 may be implemented as a cellular phone, a video phone, a smart pad, a smart watch, a tablet personal computer (PC), a car navigation system, a computer monitor, a laptop computer, a head mounted display (HMD) device, and the like.

The processor 1010 may perform various computing functions. The processor 1010 may include a micro processor, a central processing unit (CPU), an application processor (AP), or the like. The processor 1010 may be coupled to other components via an address bus, a control bus, a data bus, or the like. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like.

The I/O device 1040 may include an input device such as a keyboard, a keypad, a mouse device, a touch-pad, a touch-screen, and the like, and an output device such as a printer, a speaker, or the like. According to an embodiment, the I/O device 1040 may include the display device 1060.

The power supply 1050 may provide power for operations of the electronic device 1000.

The display device 1060 may be connected to other components through buses or other communication links.

Embodiments of the invention may be applied to a display device and an electronic device including the display device. In an embodiment, for example, the invention may be applied to a television (TV), a digital TV, a three-dimensional (3D) TV, a mobile phone, a smart phone, a tablet computer, a laptop computer, a PC, a household electronic device, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel including pixels;
a gate driver which outputs a gate signal to the pixels;
a data driver which outputs a data voltage to the pixels;
a gamma reference voltage generator which outputs an output gamma reference voltage to the data driver; and
a driving controller which controls the gate driver, the data driver, and the gamma reference voltage generator,
wherein the driving controller includes:
a voltage level determiner which determines a target gamma reference voltage corresponding to a target luminance; and
a voltage compensation level determiner which determines an offset voltage to compensate for a deviation between a first output gamma reference voltage and the target gamma reference voltage, wherein the first output gamma reference voltage is the output gamma reference voltage prior to compensation thereof, and
wherein the gamma reference voltage generator outputs a second output gamma reference voltage, which is obtained by applying the offset voltage to the first output gamma reference voltage, as the output gamma reference voltage.

2. The display device of claim 1, wherein the voltage compensation level determiner includes:
a voltage comparator which determines the deviation between the first output gamma reference voltage and the target gamma reference voltage; and
an offset voltage determiner which determines the offset voltage to compensate for the deviation.

3. The display device of claim 2, wherein the voltage comparator includes:
a first voltage comparator which determines a first deviation between the first output gamma reference voltage and the target gamma reference voltage based on a first determination criterion; and
a second voltage comparator which determines a second deviation between the first output gamma reference voltage and the target gamma reference voltage based on a second determination criterion.

4. The display device of claim 3, wherein the gamma reference voltage generator includes amplifiers and resistors, and
wherein the first voltage comparator determines the first deviation due to changes in characteristics of the amplifiers.

5. The display device of claim 3, wherein the gamma reference voltage generator includes amplifiers and resistors, and
wherein the second voltage comparator determines the second deviation due to voltage drops caused by the resistors.

6. The display device of claim 3, wherein the offset voltage determiner includes:
a first offset voltage determiner which determines a first offset voltage based on the first deviation; and
a second offset voltage determiner which determines a second offset voltage based on the second deviation.

7. The display device of claim 6, wherein when the first output gamma reference voltage is greater than the target gamma reference voltage, the first offset voltage is less than the target gamma reference voltage, and
wherein when the first output gamma reference voltage is less than the target gamma reference voltage, the first offset voltage is greater than the target gamma reference voltage.

8. The display device of claim 7, wherein a deviation between the target gamma reference voltage and the first offset voltage is equal to the first deviation.

9. The display device of claim 6, wherein when the first output gamma reference voltage is greater than the target gamma reference voltage, the second offset voltage is less than the target gamma reference voltage, and
wherein when the first output gamma reference voltage is less than the target gamma reference voltage, the second offset voltage is greater than the target gamma reference voltage.

10. The display device of claim 9, wherein a deviation between the target gamma reference voltage and the second offset voltage is equal to the second deviation.

11. A method of operating a display device, the method comprising:
determining a target gamma reference voltage corresponding to a target luminance;
comparing a first output gamma reference voltage, which is an output gamma reference voltage output from a gamma reference voltage generator prior to compensation for generating a data voltage corresponding to the target luminance, with the target gamma reference voltage;
determining an offset voltage to compensate for a deviation between the first output gamma reference voltage and the target gamma reference voltage; and
determining a second output gamma reference voltage by applying the offset voltage to the first output gamma reference voltage.

12. The method of claim 11, wherein the comparing the first output gamma reference voltage output from the gamma reference voltage generator for generating the data voltage corresponding to the target luminance, with the target gamma reference voltage includes:
determining a first deviation between the first output gamma reference voltage and the target gamma reference voltage based on a first determination criterion; and
determining a second deviation between the first output gamma reference voltage and the target gamma reference voltage based on a second determination criterion.

13. The method of claim 12, wherein the determining the offset voltage to compensate for the deviation between the first output gamma reference voltage and the target gamma reference voltage includes:
determining a first offset voltage based on the first deviation; and
determining a second offset voltage based on the second deviation.

14. The method of claim 13, wherein in the determining the first offset voltage based on the first deviation, when the first output gamma reference voltage is greater than the target gamma reference voltage, the first offset voltage is less than the target gamma reference voltage, and
wherein in the determining the first offset voltage based on the first deviation, when the first output gamma reference voltage is less than the target gamma reference voltage, the first offset voltage is greater than the target gamma reference voltage.

15. The method of claim 14, wherein a deviation between the target gamma reference voltage and the first offset voltage is equal to the first deviation.

16. The method of claim 13, wherein in the determining the second offset voltage based on the second deviation, when the first output gamma reference voltage is greater than the target gamma reference voltage, the second offset voltage is less than the target gamma reference voltage, and
wherein in the determining the second offset voltage based on the second deviation, when the first output gamma reference voltage is less than the target gamma reference voltage, the second offset voltage is greater than the target gamma reference voltage.

17. The method of claim 16, wherein a deviation between the target gamma reference voltage and the second offset voltage is equal to the second deviation.

18. An electronic device comprising:
a processor which outputs an input control signal and input image data;
a display panel including pixels;
a gate driver which outputs a gate signal to the pixels;
a data driver which outputs a data voltage to the pixels;
a gamma reference voltage generator which outputs an output gamma reference voltage to the data driver; and
a driving controller which controls the gate driver, the data driver, and the gamma reference voltage generator based on the input control signal and the input image data,
wherein the driving controller is which determines a target gamma reference voltage corresponding to a target luminance and determines an offset voltage to compensate for a deviation between a first output gamma reference voltage and the target gamma reference voltage, wherein the first output gamma reference voltage is the output gamma reference voltage prior to compensation thereof, and
wherein the gamma reference voltage generator outputs a second output gamma reference voltage, which is obtained by applying the offset voltage to the first output gamma reference voltage, as the output gamma reference voltage.

19. The electronic device of claim 18, wherein the driving controller determines a first deviation between the first output gamma reference voltage and the target gamma reference voltage based on a first determination criterion and determines a first offset voltage to compensate for the first deviation.

20. The electronic device of claim 19, wherein the driving controller is which determines a second deviation between the first output gamma reference voltage and the target gamma reference voltage based on a second determination criterion and determines a second offset voltage to compensate for the second deviation.
